(19) United States
(12) Patent Application Publication
(10) Pub. No.: US 2014/0143176 A1
(43) Pub. Date: May 22, 2014

(54) Leveraging to Minimize the Expected Inverse Assets

(71) Applicant: Rory Mulvaney, Fargo, ND (US)

(72) Inventor: Rory Mulvaney, Fargo, ND (US)

(21) Appl. No.: 14/146,810

(22) Filed: Jan. 3, 2014

Related U.S. Application Data
(63) Continuation-in-part of application No. 14/021,195, filed on Sep. 9, 2013.
Application No. 14/021,195 is a continuation-in-part of application No. 13/052,065, filed on Mar. 19, 2011.
(60) Provisional application No. 61/320,483, filed on Apr. 2, 2010.

(51) Int. Cl. G06Q 40/06

(52) U.S. Cl. CPC G06Q 40/06
USPC 705/36 R

(57) ABSTRACT

The question of how much should be placed at risk on a given investment, relative to the total assets available for investment, is basically that of determining the optimal leverage. An existing well known method for calculating optimal leverage does not appear to be derived from sound principles. The approach taken by the method described in this specification is to optimize the expected future inverse assets, conditioned on the assets having some estimated distribution. Asymptotically over time, the distribution of log-assets becomes Gaussian. Using this analysis, a couple of the more obvious strategies are ruled out, while the strategy of minimizing the reciprocal expected assets yields an elegant result that can also be interpreted in some sense as minimizing the risk of bankruptcy. Besides being applicable to Gaussian long term continuous time leveraging, methods are claimed for minimizing the inverse assets for intermediate and finite horizon continuous time leveraging, as well as for discrete time leveraging. It seems this inverse asset strategy is particularly relevant for insurance companies, financial security ratings, and financial leveraging.

### 1 TECHNICAL FIELD

A very important high-level strategy in finance relates to the amount of money to place at risk, or equivalently, how much leverage to apply. This is a field relating to Finance and Actuary Science. Because financial time series are often analyzed using probability distribution, this is also a field related to Probability Theory. Finally, numerical computing techniques from Computer Science are also involved. The invention claims seem to fit most appropriately into the U.S. patent classification 705/36R, on portfolio selection, planning, or analysis.

### 2 BACKGROUND

Leverage can be thought of as a multiplier of the value at risk, controlling the percentage of one's money that is invested or being bet on something. It is of course possible to actually invest multiples of one's assets through borrowing money “on margin” to invest it. However, this specification uses the definition that leverage is always less than or equal to 1. The leverage is a fraction, where the numerator is the portion of assets actually placed at risk as investment, and the denominator is the total portion of the gross assets that are being considered eligible for investment, possibly including available credit, but always less than or equal to the gross available assets. Any optimization is carried out with respect only to these assets considered eligible for investment.

A leverage-dependent criterion (from which the optimal leverage is derived) can be derived from the projected distribution of investment returns using a utility function. Thus there are two important variables in the process: (1) perhaps most importantly, the choice of the utility function, and (2) the choice of the model for the future distribution of returns.

Perhaps the most basic method to predict the future distribution of the logarithm of a stock price is to model it using Brownian motion with drift, also known as a Wiener process with drift, having a time-dependent Gaussian distribution “with drift” that may be expressed as

$$p ( x ; log ( {A}_{0 } ) + uT , {σ}^{2} T ) , \\ where \\ p ( x ; m , {s}^{2} ) = \frac{1}{\sqrt{2 π} s} {e}^{\frac{- {( x - m )}^{2}}{2 {s}^{2}}} . \qquad ( 1 )$$

Note that p(x;m,s²) is simply a Gaussian distribution in x with mean m and variance s². In this formula, u is the growth rate per unit time T in the log-value log(A) (where A₀ represents the starting value of the stock or assets), and σ² represents the variance of the growth in log-assets per time period. In this specification the term “volatility” refers to σ (the standard deviation of the growth in log-assets per time period), though sometimes other literature defines volatility differently.

Another simple model that may be considered is the binomial distribution for the purpose of modeling a series of win-or-lose bets. Here, the model operates in discrete time steps, whereas the lognormal stock price model above operates in continuous time.

Utility functions are a matter of importance because money is not valued on a linear scale, as illustrated by the St. Petersburg paradox[1, 2]. Bernoulli's 1738 proposed solution to this paradox was that money is probably typically measured on a logarithmic scale.

Literature from several sources on optimizing leverage point to something called the Kelly criterion [3, 4, 5, 6]. The Kelly Criterion [3] uses a logarithmic utility function in discrete time to basically show the optimal fraction of money to bet, given the true probabilities. In the simplest case of a bet on an event with two possible outcomes, the Kelly Criterion says to bet the fraction 2(p−0.5), where p is the probability of winning with the more probable guess.

According to Chan [4], the Kelly criterion, which strictly only applies to discrete probability distributions encountered in making discrete-time bets, can also be applied to continuous-time financial time series following a derivation from [5], which derives a leverage-dependent criterion in terms of μ and σ′ using a utility function that measures the expected logarithm of the assets. The quantity μ is the expected value of the simple uncompounded percent gain for a given time period, and σ′ is the standard deviation of the distribution of μ. This derivation by Thorp [5] is summarized by Chan [4] to give the simple formula for the optimal leverage in Expression 2.

$$l = \frac{μ}{{σ}^{′ 2}} \qquad ( 2 )$$

Chan [4] points out that the Kelly criterion can be used to further optimize the leverage of an asset that was chosen for its optimal Sharpe ratio, because the Sharpe ratio is basically unaffected by leverage.

A patent by Scott, et al. [7] presents the utility function in Expression 3 in terms of the expected wealth E(W), the estimated variance of the wealth Var(W), and the subjective risk tolerance variable τ.

$$U = E ( W ) - \frac{Var ( W )}{τ} \qquad ( 3 )$$

### 3 SUMMARY

### 3.1 Technical Problem

### Optimization by Evaluation of Expected Utility Results in Infinite Leverage

In a first attempt at deriving an optimal leverage criterion, one might evaluate the expected linear utility using a Brownian motion model with drift to model the logarithm of the stock price. However, as will soon be shown, there are problems with both the linear utility function and the logarithmic utility function.

In a first attempt at deriving an optimal leverage criterion, one might evaluate the expected linear utility using a Brownian motion model with drift to model the logarithm of the stock price. However, as will soon be shown, there are problems with both the linear utility function and the logarithmic utility function.

To maintain constant leverage (if the leverage is anything other than 1), transactions need to be continually made while the stock price changes. If constant leverage is continually maintained, the leveraged growth rate is simply lu, and the leveraged standard deviation is simply lσ. This is true because the leveraged change in the log price is log(1+lμᵢ), in terms of the leverage and percent increase μᵢ of the price Pᵢ (distinct from u, the increase in log-price). The Taylor series of log(1+lμᵢ) is lμᵢ plus terms of order (lμᵢ)² and higher, and because in continuous time, as opposed to discrete time, the leverage is continually maintained in small time increments, keeping |lμᵢ|<<1, so that all terms except lμ in the series may be neglected, and so the growth in the leveraged log-value is directly proportional to l. That is, for small lμ,

log(1+lμᵢ)≈lμᵢ, for small |lμᵢ|<1. (4)

And in continuous time investing, as opposed to discrete-time investing, the time increment (and thus μᵢ) can be made infinitesimally small. The direct proportionality of leveraged standard deviation follows from the direct proportionality of leveraged u.

Due to various common effects such as the law of diminishing returns and interest payments on borrowed assets, the leveraged growth rate lu may not actually grow linearly with l for larger values of l, therefore the notation u(l) is introduced as the growth rate per leverage at leverage l, to make it more general by expressing its dependence on leverage. Thus, the leveraged growth rate is expressed (somewhat redundantly, to maintain expression of the proportionality with l) as lu(l), and u(l) by itself would be fairly constant until the larger values of l are reached, where it would fall somewhat. Similar to the leveraged growth rate, the leveraged volatility is expressed as, lσ(l), with σ(l) denoting the volatility per leverage, at leverage l. For brevity, when l is in the region where leveraged growth is directly proportional to leverage, u=u(l), and accordingly as such for σ.

### 3.1.1 Problem: Linear Utility Implies Infinite Leverage

The expected linear utility of a leveraged model of Brownian motion with drift is given by Expression 5, where p(x;m,σ²) is the Gaussian probability density function in x with mean m and variance σ² from Expression 1. Expression 5 computes the expected value of e^{x}, where x represents the log-assets, having a Gaussian distribution specified by Brownian motion with drift, at time T and initial assets A₀. Thus the expected value of e^{x} is the expected value of the assets.

∫_{-∞}^{∞}e^{x}p(x; log(A₀)+lu(l)T,σ(l)²l²T)dx (5)

Evaluation of the integral in Expression 5 yields Expression 6.

$$exp ( \frac{T ( 2 lu ( l ) + {l}^{2} {σ ( l )}^{2} ) + 2 log ( {A}_{0} )}{2} ) \qquad ( 6 )$$

Therefore, maximization, with respect to leverage, of expected assets at time T, implies infinite leverage. Obviously, infinite leverage would result in bankruptcy on the slightest downturn of the stock price, but apparently the rare case of avoiding bankruptcy has such large rewards that it more than compensates for the low value of the bankrupt cases. Apparently, linear utility sacrifices too much in safety for the hope of a very lucky win.

### 3.1.2 Problem: Logarithmic Utility Implies Infinite Leverage

Evaluation of the logarithmic utility is achieved by replacing e^{x} with x in the integral in Expression 5, to compute the expected log-assets at time T (because the Gaussian distribution is expressed in terms of the logarithm of the assets). The result is given by Expression 7, which again implies infinite leverage upon maximization with respect to leverage.

Tlu(l)+log(A₀) (7)

Looking back at the derivation by Thorpe [5, sec. 7.1] of the continuous time application of the Kelly criterion and logarithmic utility function, reveals that the Taylor expansion in Formula 7.1 of [5, sec. 7.1] is wrong. That is probably the reason for the discrepancy between the analysis in Expression 7 and that given by [5, sec. 7.1]. To conclude, it appears that the Kelly Criterion still has some claim to optimality for discrete-time bets, but not for (approximately) continuous-time risk, as that seen in the stock market.

3.2 Solution to the Infinite Leverage Problem¹ ¹This solution was originally presented in [8].

Upon the above presentation of the infinite leverage problem with both linear and logarithmic utility, the hypothesis may readily be made that perhaps it works to instead minimize the multiplicative inverse of the assets [8, sec. 9]. More generally, one might propose a utility function with the goal of minimizing the expected value of y^{-b}, where y represents the random variable for the assets, and b is a positive real number. The expected value of this generalized utility function may be measured conditionally on a distribution given by the drifting Brownian motion model of the logarithm of assets, by replacing e^{x} in Expression 5 with e^{-bx}, because e^{-bx}=exp(−b log(y))=y^{-b}. Evaluation of that integral leads to Expression 8.

$$exp ( - \frac{T ( 2 blu ( l ) - {b}^{2} {l}^{2} {σ ( l )}^{2} ) + 2 b log ( {A}_{0} )}{2} ) \qquad ( 8 )$$

Minimization of Expression 8 leads to maximization, at any given T, of the simpler criterion

log(A₀)+(lu(l)−½bl²σ(l)²)T. (9)

Dropping the asset term (because it is not dependent on leverage) and dividing by T, it becomes the maximization of

$$lu ( l ) - \frac{{bl}^{2} {σ ( l )}^{2}}{2} . \qquad ( 10 )$$

This is very similar to the criterion offered by Scott, et al. [7], listed above in Expression 3, except for the important difference that Expression 10 uses its mean and variance variables computed using the logarithm of asset levels, rather than the linear asset levels used by Scott, et al. (in [7], the wealth was multiplied by the return rate plus 1 in EQ#1 of that reference, so the wealth was being measured on a linear scale). Most notably, [7] subtracted the scaled variance from the linear assets, rather than subtracting it from the logarithmic assets, making Expressions 10 and 3 very different from one another.

Differentiating Expression 10 with respect to l, and assuming lu(l)=lu, and lσ(l)=lσ, (i.e., if l is in the region where the leveraged growth rate grows linearly with leverage), and solving for 1, leads to the optimal leverage where the criterion is maximized:

$$optimal leverage , {l}_{opt} = \frac{u}{b {σ}^{2}} . \qquad ( 11 )$$

To fully specify the utility function and optimal leverage, it seems most reasonable to set b=1 in the 3 previous Expressions, making the objective to minimize the multiplicative inverse of the assets. (It should be noted that, despite the similarity between Expression 11 using b=1, and Expression 2, the parameters used have quite different definitions.) The primary motivation for this choice of b is that, intuitively, the risk of bankruptcy seems inversely proportional to the amount of assets, and thus this objective would effectively seek to directly minimize the risk of bankruptcy. The term “bankruptcy”, simplified here from its normal definition, is used in the sense that A₀, the total portion of gross assets considered eligible for investment (also used as the denominator component of the leverage) reaches zero.

This utility function differs from the linear and logarithmic utility functions in that the perceived value improves more slowly when the assets are large, as can be seen by observing that the derivatives of the linear, logarithmic, and multiplicative inverse utility functions are proportional to 1, 1/y, and 1/y², respectively. With the multiplicative inverse utility function, it takes a 50% chance of a 100% gain to offset a 50% chance of a 33% loss, because ½*½+½*1/(⅔)=1, yielding no change in the expected reciprocal assets.

### 3.2.1 Combination of Multiple Investments

Because growth rates add in linear space rather than log-space, a simple convolution of the log-return distributions does not suffice. For example, if the log return distributions being combined are Gaussian, with lognormal distributions of linear returns, the combined distribution of returns is a convolution of lognormal distributions, for which there is no simple exact mathematical expression (without using integrals) to compute even the resulting mean or standard deviation.

The expected log growth rate E[u_{c}] of a combination of random log return variables x₁, . . . , xₙ having leverages l₁, . . . , lₙ is a multidimensional integral over the joint distribution p( ) of all random log return variables being combined, as shown here:

$$E [ {u}_{c} ] = {\int }_{- ∞}^{∞} … {\int }_{- ∞}^{∞} p ( {x}_{1} , … , {x}_{n} ) log [ {\sum }_{i = 1}^{n} ( \frac{\vert {l}_{i} \vert}{{\sum }_{j = 1}^{n} \vert {l}_{j} \vert} {e}^{{l}_{i} {x}_{i}} ) ] d {x}_{1} … d {x}_{n} . \qquad ( 12 )$$

If the random log return variables xᵢ are independent, the joint distribution may be computed as the product of the marginal distributions. In the case here where the long term marginal distributions are Gaussian and possibly correlated, p is simply the multivariate Gaussian distribution with that multidimensional mean and covariance matrix (which contains the correlation information).

To gain a firmer understanding of Expression 12, observe that the linear return of a leveraged log-return lᵢxᵢ is e^{l}^{ᵢ}^{x}^{ᵢ}, and linear return rates are combined in a sum weighted with the percentage of assets for each linear return rate. The percentage of money earning the leveraged linear return rate e^{l}^{ᵢ}^{x}^{ᵢ} is so the

$$\frac{{l}_{i}}{{\sum }_{j} {l}_{j}} ,$$

overall combined leveraged linear return rate is

$${\sum }_{i} \frac{{l}_{i}}{{\sum }_{j} {l}_{j}} {e}^{{l}_{i} {x}_{i}} ,$$

and the combined leveraged log return rate is

$$log [ {\sum }_{i} \frac{{l}_{i}}{{\sum }_{j} {l}_{j}} {e}^{{l}_{i} {x}_{i}} ] .$$

The corresponding combined volatility is computed according to the formula:

$${σ}_{c} = \sqrt{\begin{matrix}- {E [ {u}_{c} ]}^{2} + {\int }_{- ∞}^{∞} … {\int }_{- ∞}^{∞} p ( {x}_{1} , … , {x}_{n} ) \\ {\{ log [ {\sum }_{i = 1}^{n} ( \frac{\vert {l}_{i} \vert}{{\sum }_{j = 1}^{n} \vert {l}_{j} \vert} {e}^{{l}_{i} {x}_{i}} ) ] \}}^{2} d {x}_{1} … d {x}_{n} .\end{matrix}} \qquad ( 13 )$$

Using this method to combine multiple leveraged log-return rates and volatilities into a single logarithmic growth rate and volatility for the entire portfolio, an optimization algorithm may be applied to find the optimal set of leverages such that Expression 9 is optimized. Notably, if money is borrowed, the interest rate and the principal repayment rate (if required) should be counted as a constant negative growth, unless there is an associated volatility in which case it can be considered as just another randomly moving investment, except having negative expected growth.

### 3.2.2 Trend Dynamics

Due to the complex dynamics of any particular application, there may be identifiable trend changes that outweigh the effects of any shorter-term Gaussian noise process. For example, during a short term temporary linear trend in the log-asset changes, the noise in the short term trend may be Gaussian. However, when the short term trend switches over to another linear rate (and possibly another volatility), the changeover must be recognized quickly and with high certainty if possible; otherwise the Gaussian leveraging strategy will not be optimal. One strategy to mitigate the problem of recognizing short term trends is to simply seek to optimize for longer term trends.

For simplicity, Expressions 8, 9, 10, and 11 have ignored the cost of borrowing for the case where leverage is large enough to necessitate it. For simplicity, they also ignore any relevant effects due to the “risk-free” interest rate. These factors are addressed in Section 4.1.

### 3.2.3 Leveraging in Range Intervals

According to Expression 11 (with b=1), investments can be leveraged for the long term using a fairly simple formula involving only the logarithmic return rate u and the squared logarithmic volatility σ². When leveraging investments specifically for the “long term”, following the hypothesis that long term return distributions tend to be Gaussian, the idea is that every infinitesimally small range interval of investments with “optimally leveraged return rate”

$${u}_{l} = \frac{{u}^{2}}{{σ}^{2}}$$

will be held long enough for their log-return distributions to become Gaussian, with leveraged mean

$${σ}_{l}^{2} = \frac{{u}^{2}}{{σ}^{2}} .$$

and leveraged variance

$${u}_{l} = \frac{{u}^{2}}{{σ}^{2}}$$

Put into actual practice, each theoretical infinitesimally small range interval may be substituted for by an arbitrarily small real range interval from some smaller value of uₗ to some greater value of uₗ. Thus, each current leveraged distribution is parameterized by the only the single parameter:

$${u}_{l} = {σ}_{l}^{2} = \frac{{u}^{2}}{{σ}^{2}} , \qquad ( 14 )$$

which may be thought of as alternately either the leveraged log-growth rate or the squared volatility thereof, and there need only be a long enough period of time for the distributions of log-returns corresponding to each range interval of the value of that parameter to become Gaussian. The time periods spent at each value of the parameter need not be contiguous, so in the long term the distribution in each infinitesimally small, 1-dimensional interval of the parameter will basically become Gaussian. Even short term trading might be observed to carry a specific average leveraged growth rate and volatility.

Although the overall momentary forecast distribution of returns may change its overall parameters for u and σ², the momentary leverage may, and should, always be adjusted to be the optimal long term leverage.

### 3.3 Problem

### Forecast Timeframe not Long Enough

Especially for stakes with less common values of

$$\frac{{u}^{2}}{{σ}^{2}}$$

or those with return distributions that stay non-Gaussian longer, sometimes investments may have a planned sale in the medium-term future (relative to the time required for its return distribution to become Gaussian); perhaps it is uncertain whether they will be held for the long term; or maybe the stake's forecast distribution is not valid all the way up to a planned future cashout. Then the long term leveraging process in [10] might not apply, and it is probably better to optimize leverage using the more general expected inverse asset objective.
3.4 Solution to the Short Forecast Timeframe (Intermediate Horizon) Problem² ²This solution was originally presented in [11].

If there is no set cashout date, there is basically a “rolling objective evaluation date” that might be limited by the maximum timeframe of a return distribution's forecast. Then one might choose to apply the more general objective of minimizing the expected inverse assets (originally suggested in [8, Section 9], and [9, Paragraph 13]) in some timeframe near the expiration of the current, but continuously extended and updated, forecast. For example, continuously optimize leverage for some time T months (perhaps 6 months) into the future. As such, the process is to apply an appropriate optimization algorithm to find the current optimal leverages for each stake in the current portfolio such that the expected inverse assets at time T, according to the forecast distributions, is minimized. Convolutions of leveraged linear return distribution forecasts for each stake must be computed to form the distribution that is the leveraged combination of several stakes.

To be clear, given a non-Gaussian log-return forecast distribution p(x,t), the leveraged log-return distribution is

$$\frac{1}{l} p ( lx , t ) ,$$

and the convolution distribution yielding the summed value z of two random linear-return variables x and y is p_{z}(t)=(pₓ*p_{y})(t)=∫pₓ(t−τ)p_{y}(τ)dτ=∫pₓ(τ)p_{y}(t−τ)dτ (with two forms to illustrate commutativity). In a simple practical application, the distributions could be expressed as histograms, and the discrete summation form of the integrals could be substituted.

### 3.5 Problem

### Planned Deleveraging (Cashout) at a Specific Time in the Future

If a stake, along with its entire class of stakes having similar return distribution characteristics, is planned to be wholly or partially cashed out of, permanently, within a time period shorter than the time required for the log-return distribution to become Gaussian, the long term leveraging process in [10] and Expressions 8-10 might not apply. As the time to cashout gets closer, the forecast distribution at cashout becomes less and less Gaussian, changing the optimal leveraging as time passes. Complicating the matter further, more cashouts are expected due to these future leveraging changes, making the leverage in one future time segment dependent on the leverage in the next time segment.

3.6 Solution for Planned Deleveraging at a Specific Time (Finite Horizon)³ ³This solution was originally presented in [11].

If there is only the single deleveraging constraint that the entire portfolio be liquidated by time T, the objective function is to minimize the expected inverse assets of the portfolio's forecast return distribution at time T. Because the position is expected to be liquidated by a fixed time, and there is less and less time for the return distribution to become Gaussian, the leverages of the stakes in the portfolio will continually change as the time approaches T, and this expectation of early deleveraging will create further dependency from one time segment to the next. Therefore, an acceptable algorithm would be to work backward in optimizing time segments, from the final to the start, by fixing the optimal leverage in the final time segment first, and optimize each successive time step up to the first. First, the optimal leverages for each stake in that final optimizing time segment are found using an appropriate optimization algorithm to tune the leverages of each stake in that time period, given the return distribution's forecast for that time period and the fact that leveraged log-return distributions are convolved together to combine them. Then step backward through the optimizing time segments, finding the optimal set of portfolio leverages (in each arbitrarily small optimizing time segment) such that the expected inverse assets of distribution p is minimized, where p is the convolution of the individual stakes' linear-return distributions in the current time segment, convolved with the already-optimized linear-return distribution for all subsequent time segments.

If there are liquidation constraints at multiple timepoints, it may be reasonable to minimize an objective function formed as a weighted mean of the expected inverse assets evaluated at various timepoints, denoted by Tᵢ, where the Tᵢ are also exactly the times where leverage constraints are imposed. More generally, if X(T) is a random variable denoting X assets at time T units into the future, the objective function to be minimized might take the form

ƒ(E[1/X(T₁)],E[1/X(T₂)], . . . E[1/X(Tₙ)]), T₁<T₂< . . . <Tₙ. (15)

That is, minimization of any function ƒ of the expected inverse assets evaluated at distinct future timepoints.

If the assets are not supposed to be fully liquidated by Tₙ, there are no Tᵢ between the final leveraging constraint and Tₙ, making the final optimizing time segment of interest (an optimizing time segment is an arbitrarily small time segment with constant leverage, not to be confused with a time period from Tᵢ to Tᵢ₊₁) a single time period with constant portfolio leverages from Tₙ₋₁, or 0 (if n=1), to Tₙ. The final Tₙ, which could also be infinite, would then be considered to be a “rolling objective evaluation point”, with the expectation that the final Tₙ remains to be a fixed value (offset relative to the current time) as time passes.

Optimization of the leverages in each arbitrarily small time segment would be much more complicated if n>1 in Expression (15), due to the inability of the above-described backward-stepping method to take into account the inverse assets from all of the as-yet unoptimized time points T, in Expression (15). Therefore optimization would probably involve simultaneous optimization of all portfolio leverages in at least all the optimizing time segments between T₁ and Tₙ.

### 3.7 Problem

### Leveraging in Discrete-Time Bets

With discrete-time bets, the Expressions 8 through 11 do not hold true. The reason is that the direct proportionality of leverage to the leveraged log-growth rate and leveraged standard deviation thereof (shown in the third paragraph of Section 3.1) no longer hold, because it is impossible to continuously adjust the leverage in small increments before a potentially large bet is won or lost. Thus, a discrete-time investment is any investment where the maximum possible likely change in value, during some small time interval during which releveraging can occur, is too large for Expression 4 to hold.

The Kelly Criterion seems to remain to have some claim to optimality for discrete-time bets. From the Background section, in the simplest case of a bet on an event with two possible outcomes, the Kelly Criterion says to bet the fraction 2(p−0.5), where p is the probability of winning with the more probable guess. Is there a similar, simply-expressible optimal criterion utilizing the concept of minimization of inverse assets, even for discrete time investments?

### 3.8 Solution to Leveraging in Discrete-Time Bets

For one trial in a simple 2-sided bet, with inverse assets, the expected utility, with probability of winning as p and betting fraction l, is

$$\frac{p}{1 + l} + \frac{1 - p}{1 - l} \qquad ( 16 )$$

Setting the differential with respect to l to zero and solving for l yields the allowable solution

$$l = \frac{1 - 2 \sqrt{p - {p}^{2}}}{2 p - 1} . \qquad ( 17 )$$

For two trials of a two-sided bet, the inverse asset objective multiplies the binomial probabilities by the inverse asset outcomes of each possibility.

$$\frac{{p}^{2}}{{( 1 + l )}^{2}} + \frac{{( 1 - p )}^{2}}{{( 1 - l )}^{2}} + 2 \frac{p ( 1 - p )}{( 1 + l ) ( 1 - l )} \qquad ( 18 )$$

Setting the differential with respect to l to zero and solving for l yields the same allowable solution as in Expression 17. In fact, a simple trial of cases 1 trial through 4 trials all yield the same optimal leverage formula for simple 2-sided bets, Expression 17, leading to the conjecture that it is valid as an optimum for any number of bets to be placed.

More generally, for winning payoff la and losing cost lc, Expression 17 becomes (again conjectured to hold for any number of Bernoulli trials)

$$l = \frac{ac - ( c + a ) \sqrt{ac ( p - {p}^{2} )}}{p ( {ac}^{2} + {a}^{2} c ) - {a}^{2} c} . \qquad ( 19 )$$

Due to this conjectured existence of an optimal leverage for discrete time betting using the inverse asset objective, along with the existence of an inverse asset optimal leverage for long term leveraging in continuous time, and the lack of a valid optimum for the Kelly Criterion or logarithmic utility in continuous time investing, it appears that minimization of inverse assets is a better overall utility function, especially if these utility functions are to be used simultaneously for both discrete-time betting and continuous-time investing.

To get the idea of how the discrete time leverage criterion in Expression 17 compares to the Kelly Criterion, consider the case when p=0.55. Expression 17 yields a betting fraction of approximately 5.01%, whereas the Kelly Criterion says to bet exactly 10%. Both criteria gradually increase the fraction to 100% as p approaches 1. According to the opinion that the inverse asset criterion is better, for the most practically relevant values of p near 0.5, the Kelly Criterion says to bet about twice as much as would be prudent, making the two criteria very different from one another.

More general multinomial distributions might substitute for binomial distributions, with different projected inverse asset levels for each corresponding probability term in the multinomial. These multinomial distributions could be histograms of past log-prices with exponentially fading weights, or some other method to forecast the current distribution. The above conjecture of optimality of the binomial distribution after one time step is not made for multinomial distributions in general however, so finding the optimal leverage for n trials of a multinomial-distributed linear-return function could require computation of multinomial n-fold autoconvolutions analogous to the way the binomial distribution of n trials is an n-fold convolution of simple Bernoulli distributions.

Convolutions of multinomial linear-return distributions would also be required for a combination of multiple investments into a portfolio, and after the convolution, the expected inverse assets would be computed. The convolutions for combining the investments would need to be carried out for various values of the leveraging vector until the leveraging vector bringing about the minimal expected inverse assets is found, using an appropriate optimization algorithm.

### 3.9 Advantageous Effects of the Invention

Intuitively the multiplicative inverse utility function seems to minimize risk of bankruptcy and, most quantifiably, true optimization of leverage is practical with a Brownian motion model with drift, in contrast to using that model with linear and logarithmic utility functions.

As Chan pointed out [4], for an investment that was chosen for its good Sharpe ratio, leverage can be further optimized, because the Sharpe ratio is basically unaffected by the leverage.

The method presented in Section 3.6 solves the problem of how to quantitatively structure a retirement fund portfolio to optimize the level of risk, using a strong mathematical basis. This objective strategy, combined with the long term leveraging strategy and general inverse asset utility function, could result in greater financial stability in the lives of millions of people, further resulting in a stronger, more broad-based, national economy. Equities markets could become more immune to crashes, due to greater common understanding of their risk levels.

### DESCRIPTION OF EMBODIMENTS

### 4.1 Example

### Leveraging in Market Equities

For basic application of optimal leverage from Expression 11 (with b=1) (which was analytically derived from the claimed Expression 9), a market equity can be modeled by Brownian motion with drift, parameterized by u and σ. The determination of u and σ from raw data is a separate non-trivial process in itself (for example, see literature on GARCH for volatility estimation), but if it is known or hypothesized that the data are produced from a particular random model with known parameters, then u (also known as the exponential growth rate) is defined as the expected increase (given that particular random model) in the log-price per time period, and σ (also known as the volatility) is defined as the standard deviation (given that particular random model) from u of those log-price changes per time period. A portfolio may be balanced even taking into account margin interest rates and covariances between market equities, using the information presented on the combination of investments from Section 3.2.1.

### 4.2 Example

### Leveraging with Debt

The root objective of minimizing the reciprocal assets seems to imply that the assets must be positive, in order for the objective to be applicable. However, because the reason for minimizing the reciprocal assets is to avoid bankruptcy, the objective given in Expression 9 also functions in cases where the net assets are negative, by simply considering the assets A₀ from the criterion in Expression 9, to be the amount used in the denominator component of the leverage (where leverage was defined in the second paragraph of Section 2), which are the amount of assets considered eligible for investment, which could include available debt.

If the debt taken has a repayment schedule, as opposed to debt without a repayment schedule such as that in a margin account, the repayment requirements usually increase with time, degrading the growth rate in the future. Thus to maintain low risk of bankruptcy in the future, a forecast is required of the earnings and volatility, and preferably their dependence on leverage, through time. Given this general forecast, the goal should be to apply a debt payoff and investment strategy (controlling the leverage through time) that aims for a steady exponential growth rate in the assets (which are considered eligible for investment) while basically maximizing the minimum, over time T, of the expected value of the function

F(t)=log(A₀)+∫₀^{T}(l(t)u(t,l)−½l(t)²σ(t,l)²)dt, (20)

where F(t) is the objective function from Expression 9 modified with b=1, as well as giving time dependence based on the forecast of u and σ, and integrating over the time-dependent portion of the function. The claimed Expression 9 is the basis for the integrand, which is integrated here with additional time dependence, and then maximized.

The optimal amount of debt to carry has also been determined, because both the debt payoff schedule and the possibility of taking additional debt were considered in the optimization process.

### 4.3 Example

### Leveraging in Insurance

Over the long term, the insurance premium per unit of insurance averages out to be greater than the average cost resulting from insurance claims, per unit of insurance, allowing the insurer to provide even more units of insurance that earn greater profits in total, probably resulting in exponential growth while the market expands. Sale of insurance is a type of financial investment, because having the ability to pay out claims means that money must be held in reserve as an investment. However, because the cost of claims over a time period is actually a random variable c, the amount of the investment should probably be considered as being the expected value of the claims over that time period, or E[c].

Denoting the random variable for claims as c and using r as the (relatively) certain amount of revenue, expected log-growth rate u (with leverage=1) is calculated as u=log(1+(r−E[c])/E[c])=log(r)−log(E[c]). If revenue is also generated from randomly-moving investments made with the insurance premiums, the revenue could be considered as a random variable also, in which case u=log(1+E[r−c]/E [c]). With revenue considered as a constant, the variance in the growth of log-assets for an interval of time T is basically computed as Tσ²=Var(Σᵢ₌₁^{T}ûᵢ)=TE[(log(r)−log(cᵢ)−u)²], where ûᵢ is considered to be the observed log growth rate over the i^{th} time interval. Here the second equality is due to the fact that the variance of a sum of independent random variables is the sum of variances of the variables.

Knowing u and σ, the analyses from Sections 4.2 and [10, Section 3.2] (specifically the claimed Expression 9 and Expression 20) are now applicable for the determination of the optimum safe leverage in terms of the optimal expected cost in claims that can be safely paid out (the leverage is the expected cost in claims divided by the assets available for investment). Leverage should be continually corrected to keep it approximately on-target, due to changes in available assets to invest (from the third paragraph of Section 3.1), or due to trend dynamics (from Section 3.2.2). This tuning of the leverage is done by buying and selling excess units of insurance or some other well-quantified financial instrument to offset the risk of a good or bad year for insurance claims. These transactions could take place in some type of market with other insurers and possibly reinsurers.

The problem mentioned about trend dynamics in [10, Section 3.2.2] should be less troublesome to predict in insurance, compared to equity markets, because insurance claims are probably less dependent upon complex quickly-changing social factors.

The insuree basically considers the opposite side of the transaction, except due to the small probability of any claim, the insuree should use the discrete-time inverse assets criterion, described in Section 3.8, to determine how much insurance to pay for. In a simple case with initial asset level A₀, expected revenue before losses r, insurance premium s, expected cost c of a claimable loss and insurance benefit function b(c), and probability p of no claimable losses, the expected inverse assets are

$$\frac{p}{{A}_{0} + r - s} + \frac{1 - p}{{A}_{0} + r - s - c + b ( c )} .$$

This function, combined with a spreadsheet enumerating example values, could aid the insuree's decision making process. Notice that the insuree's decision depends on the asset level whereas the insurer's does not, due to the insurer's presumed high level of cash flow and claim activity with the long term leveraging criterion.

### 4.4 Example

### Leveraging in a Retirement Portfolio

The framework from Sections 3.4 and 3.6 is used to basically determine the quantitative investment strategy, with only the amounts to cash out left to be determined. One possible method is to cash out a certain amount every month, after a certain date, until the money runs out. For purposes of computing leverage, the money cashed out is considered part of the total assets available to invest, but it is actually being spent every month. First, estimate the median number of months M that income will be required for, and liquidate 1/M of the leverage every month after the starting cashout date. Given that cashout schedule, the reasoning and processes described in Sections 3.4 and 3.6 may be applied.

### 5 INDUSTRIAL APPLICABILITY

Despite its simplicity, minimization of the expected multiplicative inverse assets is a non-obvious leveraging strategy, distinguished by straightforward analysis, and potentially applicable by any financial entity as their root leveraging optimization criterion. The log-normal distribution leveraging criterion in Expression 9 (along with its simpler component in Expression 10) would be particularly applicable for managing risk by insurance companies, credit rating, portfolio balancing, securities investment, company earnings history analysis, and financial advisement.

Inverse asset optimized leveraging is a process that could be applied individually to millions of retirement accounts, to quantitatively optimize a qualitative strategy. General wasteful uncertainty about market risk levels could be greatly reduced by increased consensus brought about by the mathematical soundness of the expected inverse assets objective.

### REFERENCES

[1] D. Bernoulli, “Exposition of a new theory of the measurement of risk.” Econometrica, vol. 22, pp. 22-36, 1954, translated to English by Louise Sommer, originally published 1738.
[2] S. Russell and P. Norvig, Artificial Intelligence: A Modern Approach, 2nd ed. Prentice Hall, 2002, ch. 16.3.
[3] J. Kelly, Jr., “A new interpretation of information rate,” Bell System Technical Journal, vol. 35, pp. 917-926, 1956.
[4] E. Chan, Quantitative Trading: How to Build Your Own Algorithmic Trading Business. Wiley, 2008.
[5] E. O. Thorp, “The Kelly criterion in blackjack sports betting, and the stock market,” in Proceedings of the 10th International Conference on Gambling and Risk Taking, Montreal, June 1997.
[6] W. Poundstone, Fortune's Formula. Hill and Wang, 2005.
[7] J. Scott, C. Jones, J. Shearer, and J. Watson, “Enhancing utility and diversifying model risk in a portfolio optimization framework,” U.S. Pat. No. 6,292,787, Sep. 18, 2001.
[8] R. Mulvaney and D. S. Phatak, “Regularization and diversification against overfitting and over-specialization,” University of Maryland, Baltimore County, Computer Science and Electrical Engineering TR-CS-09-03, Apr. 3 2009.
[9] R. Mulvaney, “Leveraging to minimize the expected multiplicative inverse assets,” U.S. Provisional 61/320,483, Apr. 2, 2010.
[10] ______, “Leveraging to minimize the expected multiplicative inverse assets,” U.S. Utility patent application Ser. No. 13/052,065, Mar. 19, 2011.
[11] ______, “Leveraging to minimize the expected inverse assets,” U.S. Utility patent application Ser. No. 14/021,195, Sep. 9, 2013.

1: For investments, defined as money placed at risk in return for potential gain, held long enough in total for the uncertain return distribution to be characterized approximately as a Gaussian distribution with drift in the logarithm of the investment value (as in Expression 1), the derivation and invention of a financial portfolio planning and analysis process (classification 705/36R) is claimed, using:
standard forecasts for all portfolio components of the log-growth rate u and the variance σ² of the of the above Gaussian distribution;
standard computation of leveraged, combined log-return rates and volatilities to combine forecasts of multiple investments into a single portfolio-wide log-growth rate and volatility (as specified in Section 3.2.1) based on the leverage vector; and
a standard optimization algorithm to determine the optimal portfolio leverage vector (where leverage is defined in the first paragraph of Section 2) to invest;
wherein the improvement is:
to maximize, via optimal modification of the leverage l, the value of the newly presented and logically sound objective function (upon which optimality is based) in Expression 9 for values of the constant b ranging from ⅘ to 5/4, inclusive (most preferably 1).

2: For investments having a set cashout date or partial cashout dates, and are not necessarily held long enough for the log-return distribution to be characterized as Gaussian with drift, the derivation and invention of a financial portfolio planning and analysis process (classification 705/36R) is claimed, using:
standard forecasts of the return distributions of the components of the portfolio; and
standard optimization methods to compute the optimal leverage of each portfolio element for the current time step, as described in Section 3.6;
wherein the improvement is:
to minimize a function of the form given in Expression 15.

3: For investments not necessarily held long enough for the log-return distribution to be characterized as Gaussian with drift, the derivation and invention of a financial portfolio planning and analysis process (classification 705/36R) is claimed, using:
standard forecasts of the return distributions of the components of the portfolio;
standard computation of the expected inverse assets at some time T in the future; and
a standard optimization algorithm to determine the optimal vector of portfolio leverages to invest;
wherein the improvement is to:
minimize the expected inverse assets of the return distribution at the “rolling objective evaluation date”, as described in Section 3.4.

4: For discrete-time investments as defined in Section 3.7, the derivation and invention of a financial portfolio planning and analysis process (classification 705/36R) is claimed, using:
standard forecasts of the linear-return discrete-time distributions of the components of the portfolio as specified in Section 3.8;
standard computation of leveraged, combined linear-return distributions to combine forecasts of multiple investment linear-return distributions into a single portfolio-wide linear-return discrete-time distribution, as specified in Section 3.8, based on the leverage vector; and
a standard optimization algorithm to compute the optimal leverage of each portfolio element for the current time step;
wherein the improvement is to:
minimize the expected inverse assets using the optimization function, by modifying the leveraging vector.
